(19) United States
(12) Patent Application Publication
(10) Pub. No.: US 2024/0346590 A1
(43) Pub. Date: Oct. 17, 2024

(54) TRANSACTION METHOD USING PORTABLE ENERGY STORAGE DEVICE AND COMPUTER PROGRAM PRODUCT

(71) Applicant: LI-HO YAO, Taipei City (TW)

(72) Inventor: LI-HO YAO, Taipei City (TW)

(21) Appl. No.: 18/754,184

(22) Filed: Jun. 26, 2024

Related U.S. Application Data
(63) Continuation-in-part of application No. 17/706,554, filed on Mar. 28, 2022, now abandoned.

(30) Foreign Application Priority Data
Mar. 31, 2021 (TW) 110111951

(51) Int. Cl. G06Q 40/04

(52) U.S. Cl. CPC G06Q 40/04

(57) ABSTRACT

A transaction method using portable energy storage device is provided for power dollar transaction in combination with portable electricity. The system includes a transaction management host of an electricity bank platform, a trade point device of at least one dealer, and a portable energy storage device of at least one individual member to use online connection among the transaction management host, the trade point device, and the portable energy storage device and mutual transmission of transaction data to allow the individual member to conduct transaction through the portable energy storage device and the trade point device for buying or selling electricity, or to conduct transaction for other goods by means of digital available power dollar that is formed through conversion with the electricity, in order to revitalize the green energy industry, allow all people to effectively use green energy, and create a sharing economy in the electricity market.

### CROSS REFERENCE TO RELATED APPLICATIONS

This is a continuation-in-part of co-pending U.S. patent application Ser. No. 17/706,554 filed on Mar. 28, 2022, which claims priority to Taiwanese Invention patent application Ser. No. 11/011,1951, filed on Mar. 31, 2021.

### BACKGROUND OF THE INVENTION

### (a) Technical Field of the Invention

The present invention relates to the field of trading techniques based on electrical power sharing economy.

### (b) Description of the Prior Art

In recent years, due to the increase in demand and depletion of reserves of traditional energy resources, such as coal and oil, there has been an energy shortage crisis. Coupled with its serious pollution to the environment, people have become increasingly dependent on green energy resources (which will be referred to as green energy hereinafter), such as solar energy, wind power, hydraulic power, and tidal currents. Due to the recent development of science and technology, the efficiency and stability for acquiring the above-mentioned green energy have been greatly improved, overcoming the shortcomings of high cost and instability in the past, and increasing the willingness of general households and industries to use.

However, in addition to the investment in green energy generation equipment (such as solar cells and wind turbines), existing green energy applications also include the construction of large-scale energy storage equipment and power grids. Since the investment costs and safety considerations of power grid construction are extremely high, and loss, maintenance, and risks are also very high. Therefore, most of the existing power grids are handled by large franchised institutions, and this also makes the green energy industry monopolized by large enterprises, and ordinary households or small businesses (hereinafter referred to as small individuals) can only be users of the green energy and cannot devote themselves to the green energy industry. Therefore, when the small individuals set up green energy generation equipment by themselves, in addition to self-production and self-use, any excess electricity cannot be traded or sold back into the power grids, and this reduces the intention of general people to set up green energy generation equipment.

In other words, limited by the aforementioned power trading issues, the green energy industry cannot be popularized to small individuals, resulting in the problem of greenhouse gas reduction being unable to be truly solved. As such, it is impossible to effectively create and revitalize the green energy industry. It is the issue that the present invention is made to explore in order to solve the above problems.

### SUMMARY OF THE INVENTION

Therefore, the primary objective of the present invention is to enable small individuals to use electricity for transactions, in order to activate the green energy industry, allow all people to effectively use green energy, and create a sharing economy in the electricity market.

Further, another objective of the invention is to allow ordinary households or small businesses to invest in the electrical power industry by reducing investment costs and risk losses, in order to solve the energy shortage problem and to further revitalize the economy.

Based on this, the present invention mainly adopts the following technical measure to achieve the above objectives and efficacy, which is used for an electricity bank platform, at least one dealer,and at least one individual member to execute at least one power dollar trading event, the power dollar trading event comprising exchange of electricity and a transaction of power dollars, comprising:
a transaction management host owned by an electricity bank platform, which is operable to execute a trading event management module to manage the power dollar trading event;
a trade point device of at least one dealer, which is online connection with the transaction management host for transmission of data, the trade point device being operable to execute a trading module, the transaction management host allowing at least one individual member to carry out exchange of electricity and a transaction of power dollars;
a portable energy storage device of at least one individual member, which is in near-field sensing with respect to the trade point device for transmission of data, the portable energy storage device storing electricity and being operable for calculation and conversion of electricity and power dollars, in order to convert a remaining amount of electricity into a capacity power dollar, the capacity power dollar being increased/decreased through conversion and uses to accumulate into an available power dollar;
wherein the individual member uses the portable energy storage device to carry out electricity exchange and transaction with respect to the trade point device of the corresponding dealer by means of the capacity power dollar or the available power dollar to generate a corresponding power dollar trading event, and the transaction management host of the electricity bank platform is responsible for management of the power dollar trading event.

The transaction method using portable energy storage device is applicable to a system, the system comprising a transaction management host, at least one trade point device, and at least one portable energy storage device, wherein the portable energy storage device stores electricity and calculate a remaining amount of electricity to generates a capacity power dollar, and the capacity power dollar is increased/decreased, after uses, to accumulate and generate an available power dollar, steps of the method comprising:
(a) making online connection and electrical connection of one portable energy storage device with one trade point device;
(b) establishing online connection with a transaction management host by means of the trade point device and carrying out login verification;
(c) the trade point device generating at least one trading mode for selection, wherein the trading mode comprises electricity, available power dollar, and selling/buying transaction of electricity and available power dollar;
(d) the trade point device receiving a transaction instruction to generate a power dollar trading event, the power dollar trading event including a selling/buying transaction record of using electricity and/or available power dollar of the portable energy storage device;
(e) the trade point device and the portable energy storage device executing transfer of electricity and/or available power dollar of the power dollar trading event;
(f) the trade point device subsequently making report to the transaction management host according to the power dollar trading event, and the transaction management host updating record of available power dollar of the trade point device and the portable energy storage device; and
(g) the transaction management host transmitting updated record of available power dollar back to the trade point device and the portable energy storage device for downloading and updating, and making the portable energy storage device and the trade point device offline with each other.

In thus way, through the specific implementation of the above technical measure, the present invention allows individual members to use electricity to conduct transactions through portable energy storage devices, thereby activating the green energy industry, enabling all people to effectively use green energy, and creating a sharing economy in the electricity market, to thereby reduce investment costs and risks and losses, allowing ordinary households or small businesses to participate in the green electricity industry, thereby solving the problem of energy shortage, further revitalizing the economy, thereby increasing the added value of products and enhancing economic benefits thereof.

### BRIEF DESCRIPTION OF THE DRAWINGS

FIG. 1 is a schematic view showing system architecture of the present invention.

FIG. 2 is a schematic view showing an actual system configuration of the present invention in the real world.

FIG. 3 is a flow chart illustrating a method according to the present invention.

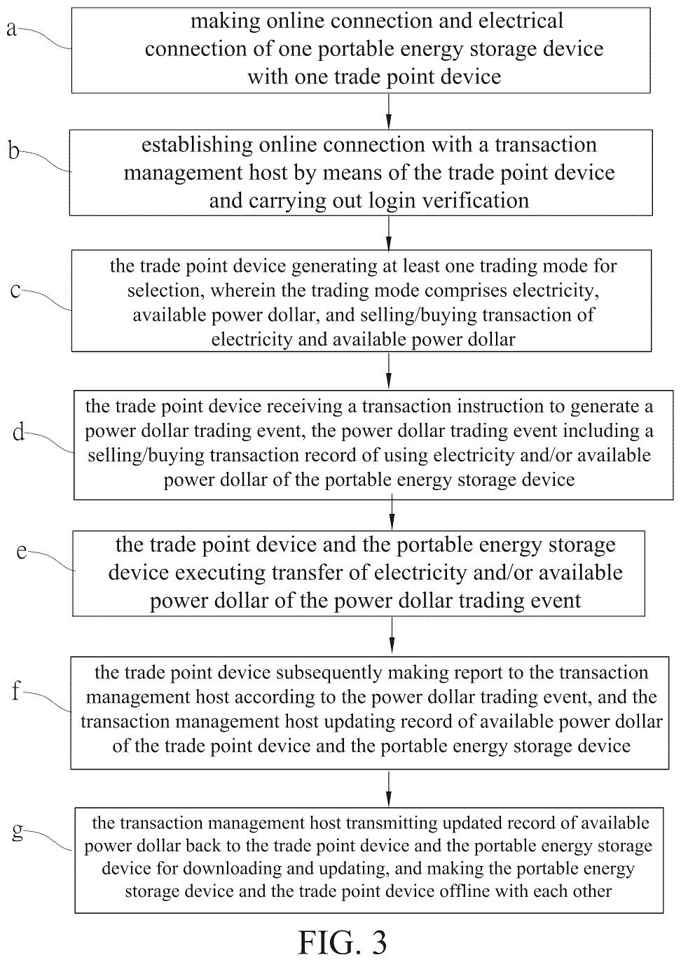

### DETAILED DESCRIPTION OF THE PREFERRED EMBODIMENTS

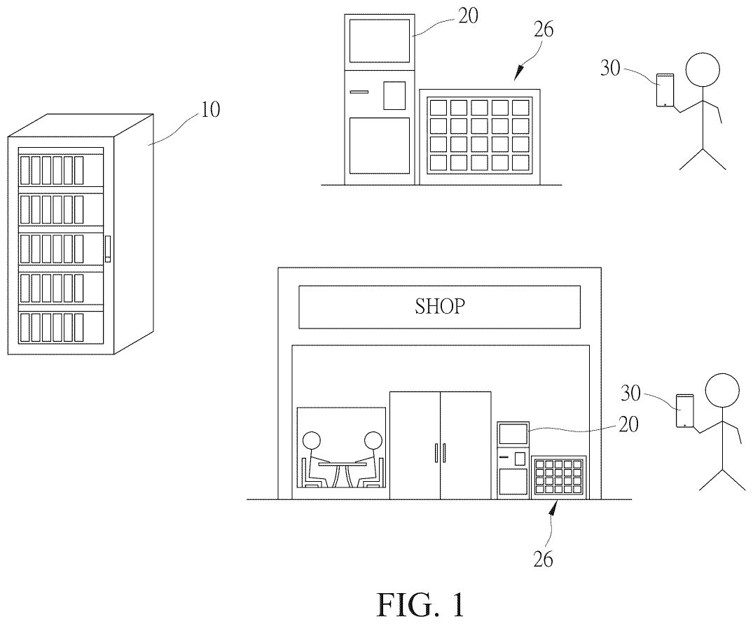

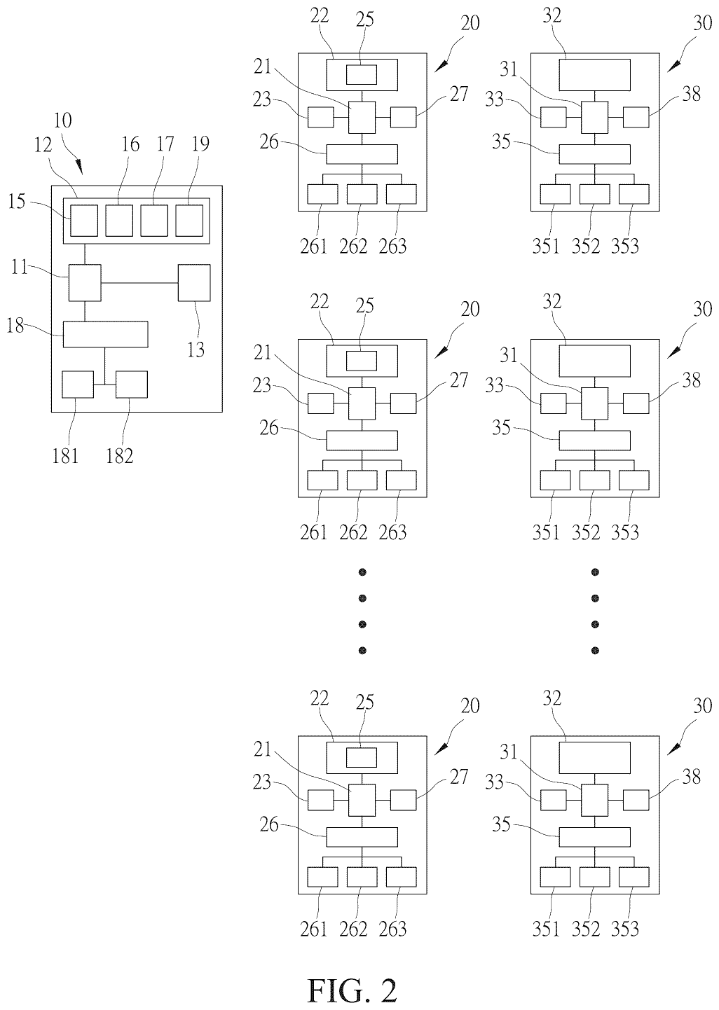

The present invention provides a transaction system using portable energy storage device, and as shown in FIGS. 1 and 2, the system comprises a transaction management host 10 of an electricity bank platform, a trade point device 20 of at least one dealer, and a portable energy storage device 30 of at least one individual member. The transaction management host 10, each trade point device 20, and each portable energy storage device 30 are connectable in a wired or wireless manner to jointly execute a computer program product of a transaction method using portable energy storage device and mutually transmit data, so that the individual member is allowed to use electricity to interact with the dealer to complete at least one power dollar trading event, and the electricity bank platform carries out records, statistics, and management of the power dollar trading event.

As to the detailed arrangement of the transaction system using portable energy storage device according to the present invention, as shown in FIGS. 1 and 2, the transaction management host 10 at least comprises a processing unit 11, a memory unit 12, a transmission unit 13, a trading event management module 15, an individual member management module 16, a dealer management module 17, and a power dollar management module 19, wherein the processing unit 11 executes at least one computer program product and processes each item of data, while the memory unit 12 is connected with the processing unit 11 and functions to store the computer program product and said each item of data, and the transmission unit 13 is connected with the processing unit 11 and is connected, by means of wireless technology or wired technology, to the trade point device 20 for on-line connection with the trade point device 20 of the at least one dealer to receive and transmit each item of transaction data, and also, the trading event management module 15 can be a computer program product built in the memory unit 12 and is on-line connectable with the trade point device 20 and the portable energy storage device 30 for execution to generate a power dollar trading event, and each power dollar trading event includes, but not limited to, conversion of electricity and power dollars, transaction objects, transaction accounting, payment transfer of power dollars, and records of power dollars, and the individual member management module 16 can be stored in the memory unit 12 and is operable online with the trading event management module 15, and further, the individual member management module 16 is operable for establishing and verifying the individual member data, storing data management of device and power dollars under an account of the individual member, and inquiring the individual member data, such as usage records, transaction records, and remaining balance of power dollars, and further, the dealer management module 17 can be stored in the memory unit 12 and is operable online with the trading event management module 15, and also, the dealer management module 17 is operable for establishing and verifying dealer data, storing data management of device under an account of each dealer, and inquiring the dealer data, such as usage records and transaction records, and further, the power dollar management module 19 is connected with the processing unit 11 for carrying out, including but not limited to, conversion, management, exchange, donation, transfer, or profit sharing of power dollars, wherein the power dollars can be valuable assets of an equivalency of cash, such as digital points, virtual currency, or carbon credits. According to some embodiments, the transaction management host 10 further comprises an electrical power management unit 18 connected with the processing unit 11, and the electrical power management unit 18 is in connection with at least one electrical power connection port 181 and at least one energy storage equipment 182, wherein the electrical power management unit 18 functions to manage and control electricity inputting into/outputting from each energy storage equipment 182 through each electrical power connection port 181 and conversion of electricity and power dollars, and the electrical power connection port 181 is connectable with external power sources, such as power grids, and the energy storage equipment 182 functions to store electrical power to serve as a super huge storage battery.

The trade point device 20 is a piece of equipment to be installed by the dealer, and the trade point device 20 at least comprises a processing unit 21, a memory unit 22, a transmission unit 23, a trading module 25, an electricity exchange unit 26, and a near field sensing unit 27, wherein the processing unit 21 is operable to execute a computer program product and process each item of data, and the memory unit 22 is connected with the processing unit 21, and the memory unit 22 functions to store programs and each item of data, and also, the transmission unit 23 is connected with the processing unit 21 and is connected, by means of wireless technology or wired technology, to the transaction management host 10 for on-line connection to receive and transmit each item of transaction data, and also, the trading module 25 can be a computer program product built in the memory unit 22 and has the function of selecting a. trading mode, and also, the electricity exchange unit 26 is connected with the processing unit 21 and is operable for transfer of electricity with respect to the portable energy storage device 30, and the electricity exchange unit 26 may comprise an electrical power management unit 261 and at least one electrical power connection port 262 and at least one energy storage equipment 263 connected with the electrical power management unit 261, wherein the electrical power management unit 261 functions to manage and control electricity inputting into/outputting from each energy storage equipment 263 through each electrical power connection port 262, and the electricity exchange unit 26 is operable to carry out calculation and conversion between electricity and power dollars, and the near field sensing unit 27 can be a sensing element of near field communication (NFC) or Bluetooth, and is operable for transfer of power dollars with respect to the portable energy storage device 30 to generate a power dollar trading event.

The portable energy storage device 30 at least comprises a processing unit 31, a memory unit 32, a near field sensing unit 33, and an electrical power accumulation unit 35, wherein the processing unit 31 is operable to execute a computer program product and process each item of data, and the memory unit 32 is connected with the processing unit 31 functions to store programs, electricity value, power dollars, and each item of data, and the near field sensing unit 33 is connected with the processing unit 31 can be a sensing element of NFC or Bluetooth of wireless technology for receiving and transmitting each item of transaction data with respect to the near field sensing unit 27 of the trade point device 20, and also, the electrical power accumulation unit 35 is connected with the processing unit 31, and the electrical power accumulation unit 35 is operable to carry out transfer of electricity with respect to the electricity exchange unit 26 of the trade point device 20, and the electrical power accumulation unit 35 may comprise an electrical power management unit 351 and an electrical power connection port 352 and an energy accumulation unit 353 connected with the electrical power management unit 351, wherein the electrical power management unit 351 functions to manage and control electricity inputting into/outputting from each energy accumulation unit 353 through each electrical power connection port 352, and the electrical power accumulation unit 35 is operable to carry out calculation and conversion between electricity and power dollars, including conversion of electricity remaining in the energy accumulation unit 353 into a capacity power dollar, and storage of data related to the capacity power dollar an available power dollar counted after use in the memory unit 32. Further, according to some embodiments, the portable energy storage device 30 further comprise a transmission unit 38 connected with the processing unit 31, and the transmission unit 38 is connected, by means of wireless technology or wired technology, to the transaction management host 10 for online connection to receive and transmit each item of transaction data, so that each portable energy storage device 30 is also operable to trade with another portable energy storage device 30.

As such, a transaction system using portable energy storage device is formed for combination with electricity and application to trading.

In an actual use of the present invention, as shown in FIGS. 1 and 2, the transaction management host 10 of the electricity bank platform generates a power dollar trading event for the portable energy storage device 30 of the at least one individual member carrying out trading with electricity or power dollars in the trade point device 20 of the at least one dealer, and effectively records, stores, compiles statistics, and manages the data of information of the power dollar trading events, and the actual use of the present invention can be better understood with the following example, such as:

### EXAMPLE 1: ENERGY STORAGE AND TRANSACTION MODE OF PORTABLE ENERGY STORAGE DEVICE 30

An individual member uses the portable energy storage device 30 owned thereby to proceed with registration and verification of member data and device in the transaction management host 10 of the electricity bank platform, and the individual member operates self-installed energy generation equipment, such as solar cells and wind power generators, to generate electricity, and inputs and stores the electricity through the electrical power accumulation unit 35 of the portable energy storage device 30 into the energy accumulation unit 353, and uses the electrical power management unit 351 to record and convert the stored electricity capacity into capacity power dollars. For example, in case that 1000 mAh (milliampere hour) is convertible into one (1) power dollar (abbreviated as PD herein), the maximum capacity power dollar of the energy accumulation unit 353 having a capacity is of 100,000 mAh is 100 PD, and for the energy accumulation unit 353 having a remaining capacity of 65000 mAh after uses, the tradable capacity power dollar thereof is 65 PD, and this is stored in the memory unit 32 of the portable energy storage device 30. Further, the memory unit 32 of the portable energy storage device 30 may store a remaining accumulated amount of available power dollar of the individual member after multiple times of trading. For example, after the individual member sells for 12 times the electricity of full capacity of the energy accumulation unit 353, the accumulated amount of available power dollar is 1200 PD. As such, when the individual member carries out trading of electricity, operation of addition and subtraction is performed with the capacity power dollar, and the individual member is also allowed to use the available power dollar to make direct trading.

### EXAMPLE 2: ELECTRICITY EXCHANGE AND TRANSACTION MODE OF TRADE POINT DEVICE 20

A dealer can be a shop, such as a battery exchange station and a convenience store, which is capable of exchange of electricity and/or sale of goods. The dealer sets up at least one trade point device 20, and the dealer proceeds with registration and verification of member data and device for the trade point device 20 owned thereby in the transaction management host 10 of the electricity bank platform, and establishes online connection of the trade point device 20 with the transaction management host 10 of the electricity bank platform, and also, the trade point device 20 uses the electrical power connection port 262 of the electricity exchange unit 26 for connection with the electrical power connection port 352 of the portable energy storage device 30 of an individual member for exchange of electricity, and to carry out trade with the capacity power dollar or the available power dollar of the individual member by means of the near field sensing units 27, 33 of the two, and online connection is set up between the transaction management host 10 and the trade point device 20 to transmit transaction data to the transaction management host 10 to generate a power dollar trading event, which is recorded and stored in the transaction management host 10.

### EXAMPLE 3: MODE OF TRADING WITH ELECTRICITY BETWEEN PORTABLE ENERGY STORAGE DEVICE 30 AND TRADE POINT DEVICE 20

An individual member uses the portable energy storage device 30 owned thereby to sell or buy electricity with the trade point device 20 of a dealer. Taking selling electricity as an example, the individual member first operates energy generation equipment, such as solar cells and wind power generators, to generate electricity or makes charges with traditional power grids, and stores the electricity in the energy accumulation unit 353 of the electrical power accumulation unit 35 of the portable energy storage device 30, and uses the electrical power management unit 351 of the electrical power accumulation unit 35 to convert stored electricity capacity into capacity power dollar. For example, the storage capacity of the energy accumulation unit 353 is 100000 mAh, and the capacity power dollar is 100 PD, and the individual member may select to sell 80000 mAh by connecting the electrical power connection port 352 of the portable energy storage device 30 to the electrical power connection port 262 of the electricity exchange unit 26 of the trade point device 20, and also placing the portable energy storage device 30 on the trade point device 20 to have the near field sensing units 33, 27 of the two sensing each other, and operating the trading module 25 of the trade point device 20 to select selling electricity and a sale amount (such as 80 PD of the capacity power dollar, and at this moment, the portable energy storage device 30 uses the electrical power accumulation unit 35 to transfer 80000 mAh to the energy storage equipment 263 of the electricity exchange unit 26 of the trade point device 20, and also, the trade point device 20 counts 80 PD in the available power dollar of the memory unit 32 of the portable energy storage device 30, and at this moment, the memory unit 32 of the portable energy storage device 30 records therein a remaining amount of the capacity power dollar to be 20PD (remaining electricity capacity being 20000 mAh) and the available power dollar being 80 PD, and a power dollar trading event is thus generated, and the trade point device 20 transmits the power dollar trading event to the trading event management module 15 of the transaction management host 10 to proceed with data storage and management. In an example of buying electricity, the individual member, for a need of electricity, brings the portable energy storage device 30 owned thereby to a dealer to use the trade point device 20 owned thereby to buy electricity, and the individual member connects the electrical power connection port 352 of the portable energy storage device 30 to the electrical power connection port 262 of the electricity exchange unit 26 of the trade point device 20, and also places the portable energy storage device 30 on the trade point device 20 to have the near field sensing units 33, 27 of the two sensing each other, and then operates the trading module 25 of the trade point device 20 to select buying electricity and a required amount (such as 75 PD of capacity power dollar), and at this moment, the energy storage equipment 263 of the trade point device 20 transfers an electricity capacity of 75000 mAh to the energy accumulation unit 353 of the portable energy storage device 30, and also, the trade point device 20 deducts 75 PD from the available power dollar of the memory unit 32 of the portable energy storage device 30, such as the available power dollar initially owned by the portable energy storage device 30 being 250 PD, and now only 175 PD left, and also the memory unit 32 of the portable energy storage device 30 records a remaining amount of the capacity power dollar increasing by 75 PD (meaning remaining electricity capacity being increased by 75000 mAh, such as increasing from 5000 mAh to 80000 mAh), and a power dollar trading event is thus generated, and the trade point device 20 transmits the power dollar trading event to the trading event management module 15 of the transaction management host 10 to proceed with data storage and management.

### EXAMPLE 4: MODE OF TRADING WITH POWER DOLLAR BETWEEN PORTABLE ENERGY STORAGE DEVICE 30 AND TRADE POINT DEVICE 20

An individual member uses the portable energy storage device 30 owned thereby to directly trade with the trade point device 20 of a dealer for trading other goods with the available power dollar. For example, the portable energy storage device 30 of the individual member records therein an available power dollar of 650 PD, and the individual member may directly purchase desired goods from the dealer, such as purchasing a cup of coffee with 50 PD, and the individual member directly places the portable energy storage device 30 on the trade point device 20 to have the near field sensing units 33, 27 of the two sensing each other, and operates the trading module 25 of the trade point device 20 to select trading with available power dollar, and the trade point device 20 directly deduct 50 PD of available power dollar from the portable energy storage device 30, so that a remaining amount of the available power dollar recorded in the memory unit 32 of the portable energy storage device 30 becomes 600 PD, and a power dollar trading event is thus generated, and the trade point device 20 transmits the power dollar trading event to the trading event management module 15 of the transaction management host 10 to proceed with data storage and management.

### EXAMPLE 5: MODE OF TRADING WITH ELECTRICITY BETWEEN ONE PORTABLE ENERGY STORAGE DEVICE 30 AND ANOTHER PORTABLE ENERGY STORAGE DEVICE 30

An individual member may sell or buy electricity to or from another individual member. At least one of the portable energy storage devices 30 owned by the two individual members includes the transmission unit 38 for online connection with the transaction management host 10 of the electricity bank. Taking selling electricity as an example, the one of the portable energy storage devices 30 that includes the transmission unit 38 is defined as first portable energy storage device 30, while another one of the portable energy storage devices 30 is defined as second portable energy storage device 30, and then, the first and second portable energy storage devices 30 are connected to each other by means of the electrical power connection ports 352, and also, the near field sensing units 33 of the first and second portable energy storage devices 30 sense each other, and the electrical power accumulation unit 35 of the first portable energy storage device 30 selects selling electricity and a sale amount (such as 60 PD of the capacity power dollar), and at this moment, the first portable energy storage device 30 transfers, through the electrical power accumulation unit 35, 60000 mAh to the energy accumulation unit 353 of the electrical power accumulation unit 35 of the second portable energy storage device 30, and also, the first portable energy storage device 30 deducts 60 PD of available power dollar from the second portable energy storage device 30, and the available power dollar of the first portable energy storage device 30 is increased by 60 PD, so that the memory unit 32 of the first portable energy storage device 30 records a remaining amount of capacity power dollar being deducted by 60 PD (meaning a remaining electricity capacity decreasing by 60000 mAh), and the available power dollar is increased by 60 PD, while the memory unit 32 of the second portable energy storage device 30 records a remaining amount of the capacity power dollar being increased by 60 PD (meaning a remaining electricity capacity being increased by 60000 mAh), and the available power dollar is deducted by 60 PD, and a power dollar trading event is generated, and the first portable energy storage device 30 transmits the power dollar trading event to the trading event management module 15 of the transaction management host 10 to proceed with data storage and management.

A transaction method using portable energy storage device according to the present invention is implementable with the aforementioned system, comprising a flow of steps as follows:
(a) making online connection and electrical connection of one portable energy storage device with one trade point device: an individual member makes information connection and electrical connection of a portable energy storage device 30 owned thereby and storing therein green electricity with a trade point device 20 of a dealer, wherein according to some embodiments, the portable energy storage device 30 may also be a trade point device 20, so that the two portable energy storage devices 30 may establish information connection and electrical connection therebetween;
(b) establishing online connection with a transaction management host by means of the trade point device and carrying out login verification: the trade point device 20 that is in online connection with the portable energy storage device 30 further establishes online connection with a transaction management host 10 at a remote site, and meanwhile, the trade point device 20 uploads data of the portable energy storage device 30 to proceed with account login and verification with respect to the transaction management host 10;
(c) the trade point device generating at least one trading mode for selection, wherein the trading mode comprises electricity, available power dollar, and selling/buying transaction of electricity and available power dollar: the trade point device 20 generates a transaction screen, and the transaction screen includes selection of at least one trading mode of electricity, available power dollar, and selling/buying transaction of electricity and available power dollar, such as the individual member using electricity and available power dollar of the portable energy storage device 30 to buy a cup of coffee from the dealer, or the individual member using available power dollar of the portable energy storage device 30 to buy electricity from the dealer, or even more, the individual member selling electricity of the portable energy storage device 30 to the trade point device 20 of the dealer;
(d) the trade point device receiving a transaction instruction to generate a power dollar trading event, the power dollar trading event including a selling/buying transaction record of using electricity and/or available power dollar of the portable energy storage device: the trade point device 20 generates, according to an instruction of the previously selected trading mode, a transaction record of transfer or increase/decrease of electricity or available power dollar of the portable energy storage device 30, so as to form a power dollar trading event;
(e) the trade point device and the portable energy storage device executing transfer of electricity and/or available power dollar of the power dollar trading event: based on the transaction record of the power dollar trading event, the trade point device 20 and the portable energy storage device 30 execute corresponding transfer of electricity and/or available power dollar;
(f) the trade point device subsequently making report to the transaction management host according to the power dollar trading event, and the transaction management host updating record of available power dollar of the trade point device and the portable energy storage device: when the trade point device 20 and the portable energy storage device 30, after completing operation of the power dollar trading event, transmit record of the power dollar trading event back to the transaction management host 10, and the transaction management host 10 updates account data corresponding to the trade point device 20 and the portable energy storage device 30 to enable subsequent management, records, and inquiry of the dealer and the individual member by the electricity bank platform; and
(g) the transaction management host transmitting updated record of available power dollar back to the trade point device and the portable energy storage device for downloading and updating, and making the portable energy storage device and the trade point device offline with each other: finally, the transaction management host 10 transmits updated record of available power dollar of the account back to the trade point device 20 to be forwarded by the trade point device 20 to the portable energy storage device 30 for separately downloading and updating so as to have the transaction management host 10, the trade point device 20, and the portable energy storage device 30 all possess the latest data of available power dollar, and after the completion of the transaction, the portable energy storage device 30 and the trade point device 20 are set offline with each other to finish the transaction.

The above described steps of the transaction method using portable energy storage device can form a computer program product, and the computer program product can be installed in the previously described transaction system using portable energy storage device, which includes a transaction management host 10, at least one trade point device 20, and at least one portable energy storage device 30.

As can be learned from the forgoing, the present invention allows individual members to use electricity for transactions, so as to activate the green energy industry, enable all people to effectively use green energy, and create a sharing economy in the electricity market, and can reduce investment costs and risk losses so as to allow ordinary households or small businesses to invest in the electrical power industry to thereby solve the problem of energy shortage, and to further revitalize the economy. thus increasing the added value of products and improving their economic benefits.

I claim:

1. A transaction method using portable energy storage device, which is applicable to a system, the system comprising a transaction management host, at least one trade point device, and at least one portable energy storage device, wherein the portable energy storage device stores electricity and calculates a remaining amount of the electricity to generate a capacity power dollar, the capacity power dollar being increased/decreased after a use to accumulate and generate an available power dollar, steps of the method comprising:
(a) making online connection and electrical connection of one portable energy storage device with one trade point device;
(b) establishing online connection with a transaction management host by means of the trade point device and carrying out login verification;
(c) the trade point device generating at least one trading mode for selection, wherein the trading mode comprises electricity, available power dollar, and selling/buying transaction of electricity and available power dollar;
(d) the trade point device receiving a transaction instruction to generate a power dollar trading event, the power dollar trading event including a selling/buying transaction record of using electricity and/or available power dollar of the portable energy storage device;
(e) the trade point device and the portable energy storage device executing transfer of electricity and/or available power dollar of the power dollar trading event;
(f) the trade point device subsequently making report to the transaction management host according to the power dollar trading event, and the transaction management host updating record of available power dollar of the trade point device and the portable energy storage device; and
(g) the transaction management host transmitting updated record of available power dollar back to the trade point device and the portable energy storage device for downloading and updating, and making the portable energy storage device and the trade point device offline with each other;
wherein the transaction management host, the trade point device, and the portable energy storage device jointly execute at least one power dollar trading event, and the power dollar trading event comprises an exchange of electricity and/or a selling/buying transaction of power dollar.

2. The transaction method using portable energy storage device according to claim 1, wherein the portable energy storage device is alternatively a trade point device, so that the portable energy storage device the transmission unit is online connectable with the transaction management host to allow the portable energy storage device to trade with another portable energy storage device.

3. A computer program product, installed in a system comprising a transaction management host, at least one trade point device, and at least one portable energy storage device, the system executing the computer program product to realize the steps of the transaction method using portable energy storage device according to claim 1.

4. A computer program product, installed in a system comprising a transaction management host, at least one trade point device, and at least one portable energy storage device, the system executing the computer program product to realize the steps of the transaction method using portable energy storage device according to claim 2.
